(19) United States
(12) Patent Application Publication
(10) Pub. No.: US 2017/0287215 A1
(43) Pub. Date: Oct. 5, 2017

(54) PASS-THROUGH CAMERA USER INTERFACE ELEMENTS FOR VIRTUAL REALITY

(71) Applicant: GOOGLE INC., Mountain View, CA (US)

(72) Inventors: Paul Albert LALONDE, Sunnyvale, CA (US); Mark DOCHTERMANN, Mountain View, CA (US); Alexander James FAABORG, Mountain View, CA (US); Ryan OVERBECK, Mountain View, CA (US)

(21) Appl. No.: 15/083,982

(22) Filed: Mar. 29, 2016

(51) Int. Cl. G06T 19/00; H04N 5/225; G06T 11/60; G06F 3/01; G06F 3/0484

(52) U.S. Cl. CPC G06T 19/006; G06F 3/012; G06F 3/013; G06F 3/04842; G06T 11/60; H04N 5/225

(57) ABSTRACT

Systems and methods are described for generating a virtual reality experience including generating a user interface with a plurality of regions on a display in a head-mounted display device. The head-mounted display device housing may include at least one pass-through camera device. The systems and methods can include obtaining image content from the at least one pass-through camera device and displaying a plurality of virtual objects in a first region of the plurality of regions in the user interface, the first region substantially filling a field of view of the display in the head-mounted display device. In response to detecting a change in a head position of a user operating the head-mounted display device, the methods and systems can initiate display of updated image content in a second region of the user interface.

### TECHNICAL FIELD

This document relates to graphical user interfaces for computer systems and, in particular, to Virtual Reality (VR) displays for use in VR and related applications.

### BACKGROUND

A head-mounted display (HMD) device is a type of mobile electronic device which may be worn by a user, for example, on a head of the user, to view and interact with content displayed on a display within the HMD device. An HMD device may include audio and visual content. The visual content may be accessed, uploaded, streamed, or otherwise obtained and provided in the HMD device.

### SUMMARY

In one general aspect, a computer-implemented method includes generating a virtual reality experience including generating a user interface with having a plurality of regions. The user interface may be on a display in a head-mounted display device that houses at least one pass-through camera device. The method may include obtaining image content from the at least one pass-through camera device, displaying a plurality of virtual objects in a first region of the plurality of regions in the user interface. The first region may substantially fill a field of view of the display in the head-mounted display device. In response to detecting a change in a head position of a user operating the head-mounted display device, the method may include initiating display of updated image content in a second region of the plurality of regions in the user interface. The second region may be composited into content displayed in the first region. In some implementations, displaying the second region is based on detecting a change in eye gaze of the user.

Example implementations may include one or more of the following features. The updated image content may be associated with a real-time image feed obtained by the at least one pass-through camera and captured in a direction corresponding to the change in head position. In some implementations, the updated image content includes the second region and a third region, of the plurality of regions, composited into the first region and the first region includes scenery surrounding the plurality of virtual objects. In some implementations, the third region may be composited into the first region, in response to detecting movement in front of a lens of the at least one pass-through camera. In some implementations, the updated image content includes video composited with the content displayed in the first region, corrected according to at least one eye position associated with the user, rectified based on a display size associated with the head-mounted display device, and projected in the display of the head-mounted display device.

In some implementations, the first region includes virtual content and the second region includes video content that is a blended into the first region. In some implementations, the first region is configurable to a first stencil shape and the second region is configurable to a second stencil shape complimentary to the first stencil shape. In some implementations, display of the second region is triggered by a hand motion performed by the user and in the shape of a brushstroke placed as an overlay on the first region.

In some implementations, the method may also include detecting an additional change in head position of the user, and in response, removing from display, the second region of the user interface. Removing the second region from display may include fading a plurality of pixels associated with the image content, from opaque to transparent, until the second region is indiscernible and removed from view for the user operating the head-mounted display device.

In some implementations, detecting an additional change in head position of the user includes detecting a downward cast eye gaze and in response, displaying a third region in the user interface, the third region being displayed within the first region and in the direction of the eye gaze and including a plurality of images of a body of the user operating the head mounted display device. The images may be initiated from the at least one pass-through camera and depicted as a real-time video feed of the body of the user from a perspective associated with the downward cast eye gaze.

In some implementations, the method may include detecting a plurality of physical objects in the image content that are within a threshold distance of the user operating the head-mounted display device. In response to detecting, using a sensor, that the user is proximate to at least one of the physical objects, the method can include initiating display of a camera feed associated with the pass-through camera and the at least one physical object, in at least one region of the user interface, while the at least one physical object is within a predefined proximity threshold, the initiated display including the at least one object in at least one region incorporated into the first region. In some implementations, the at least one of the physical objects includes another user approaching the user operating the head-mounted display device.

In a second general aspect, a system is described that includes a plurality of pass-through cameras and a head-mounted display device. The head-mounted display device may include a plurality of sensors, a configurable user interface associated with the head-mounted display device, and a graphics processing unit. The graphics processing unit may be programmed to bind a plurality of textures of image content obtained from the plurality of pass-through cameras and determine a location within the user interface in which to display the plurality of textures.

Example implementations may include one or more of the following features. In some implementations, the system further includes a hardware compositing layer operable to display image content retrieved from the plurality of pass-through cameras and composite the image content within virtual content displayed on the head-mounted display device. The display may be configured in a location on the user interface and according to a shaped stencil selected by a user operating the head-mounted display device.

In some implementations, the system is programmed to detect a change in a head position of a user operating the head-mounted display device, initiate display of updated image content in a first region of the user interface. The first region may be composited into content displayed in a second region. Thee updated image may be content being associated with a real-time image feed obtained by at least one of the plurality of pass-through cameras.

In a third general aspect, a computer-implemented method includes providing, with a processor, a tool for generating virtual reality user interfaces. The tool may be programmed to allow the processor to provide a plurality of selectable regions in a virtual reality user interface, a plurality of overlays for providing image content retrieved from a plurality of pass-through cameras within at least one of the plurality of regions, and a plurality of selectable stencils configured to define display behavior of the plurality of overlays and the plurality of regions. The display behavior may be executed in response to at least one detected event.

The method may also include receiving a selection of a first region from the plurality of selectable regions, a second region from the plurality of selectable regions, at least one overlay from the plurality of overlays, and a stencil from the plurality of selectable stencils. The method may also include generating a display that includes the first region and the second region, the second region including the at least one overlay, shaped according to the stencil and responsive to the defined display behavior of the at least one overlay.

Example implementations may include one or more of the following features. In some implementations, the defined display behavior of the overlay includes providing the image content in response to detecting approaching physical objects.

In some implementations, the method includes receiving configuration data for displaying the first region, the second region, and the at least one overlay according to the stencil and generating a display that includes the first region and the second region. The second region may include the at least one overlay shaped according to the stencil, the configuration data, and responsive to the defined display behavior for the at least one overlay.

In some implementations, the plurality of selectable stencils include a plurality of brushstrokes paintable as a shaped overlay image on the first or second region. In some implementations, the plurality of regions in the virtual reality user interface are configurable to be blended with virtual content and cross-faded amongst image content displayed in the user interface based on a pre-selected stencil shape.

Other embodiments of this aspect include corresponding computer systems, apparatus, and computer programs recorded on one or more computer storage devices, each configured to perform the actions of the methods.

The details of one or more implementations are set forth in the accompanying drawings and the description below. Other features will be apparent from the description and drawings, and from the claims.

### BRIEF DESCRIPTION OF THE DRAWINGS

FIG. 1 is an example of a user interacting with a virtual reality environment.

FIG. 2 is a block diagram of an example virtual reality system for implementing 3D virtual reality (VR) environments.

FIG. 3 illustrates an example visual field of view for a user moving while wearing an HMD device.

FIG. 4 illustrates an example of virtual content and pass-through camera content in the HMD device.

FIGS. 5A-5B illustrate examples of physical world content and virtual content using pass-through content in an HMD device.

FIG. 6 is a flow chart of a process for providing user interface elements in the HMD device.

FIG. 7 is a flow chart of a process for generating user interface elements in the HMD device.

FIG. 8 shows an example of a computer device and a mobile computer device that can be used to implement the techniques described here.

Like reference symbols in the various drawings indicate like elements.

### DETAILED DESCRIPTION

A Virtual Reality (VR) system and/or an Augmented Reality (AR) system may include, for example, a head-mounted display (HMD) device, VR headset, or similar device or combination of devices worn by a user to generate an immersive virtual world environment to be experienced by the user. The immersive virtual world environment may be viewed and experienced by the user via the HMD device, which may include various different optical components that generate images, effects, and/or interactive elements and the like to enhance the immersive virtual world experience for the user.

Such optical components can include pass-through cameras mounted to (or incorporated into) a display associated with an HMD device. Image content captured by the pass-through cameras can be combined with virtual content in a display of the HMD device configured to provide a number of graphical user interface (GUI) configurations. The GUI configurations may refer to locations of pass-through areas or virtual content areas with respect to a view provided to the user, a ratio of pass-through content to virtual content, a ratio of fade or transparency of any content provided within the HMD device, and/or a shape or size associated with the virtual content or the pass-through content or both, just to name a few examples.

In general, the systems and methods described herein can provide a substantially seamless visual experience in which the visual field from the eyes of the user to the displayed content is not obstructed or limited by, for example, poorly placed or untimely placed pass-through content. Instead, the systems and methods described herein can use the pass-through content to enhance the immersive virtual experience for the user. For example, providing pass-through content areas and displays in a less obtrusive manner, shape, and/or location can enrich the virtual experience for the user. Thus, information about the physical world can be selectively provided to the user in image or sound form while the user remains in the virtual environment. For example, content from one or more of the pass-through cameras can be provided in selective pass-through regions. Such regions can be configured to provide pass-through content upon encountering particular triggers including, but not limited to motions, sounds, gestures, preconfigured events, user movement changes, etc.

The systems and methods described herein can obtain and use knowledge regarding user context including information about a physical world (i.e., real world) surrounding the user, a location and/or gaze associated with the user, and context about virtual content being providing within the HMD device worn by the user. Such information can allow a VR director or VR content creator to adapt virtual content to allow for determined user context when providing real world (i.e., physical world) image and/or video content in pass-through content areas without detracting the user from the immersive virtual experience. The content provided in the HMD device can be any combination of virtual content, augmented reality content, direct camera feed content, pass-through camera feed content, or other visual, audio, or interactive content. The content can be placed without modifications, modified for display, embedded, merged, stacked, split, re-rendered, or otherwise manipulated to be appropriately provided to the user without interrupting the immersive virtual experience.

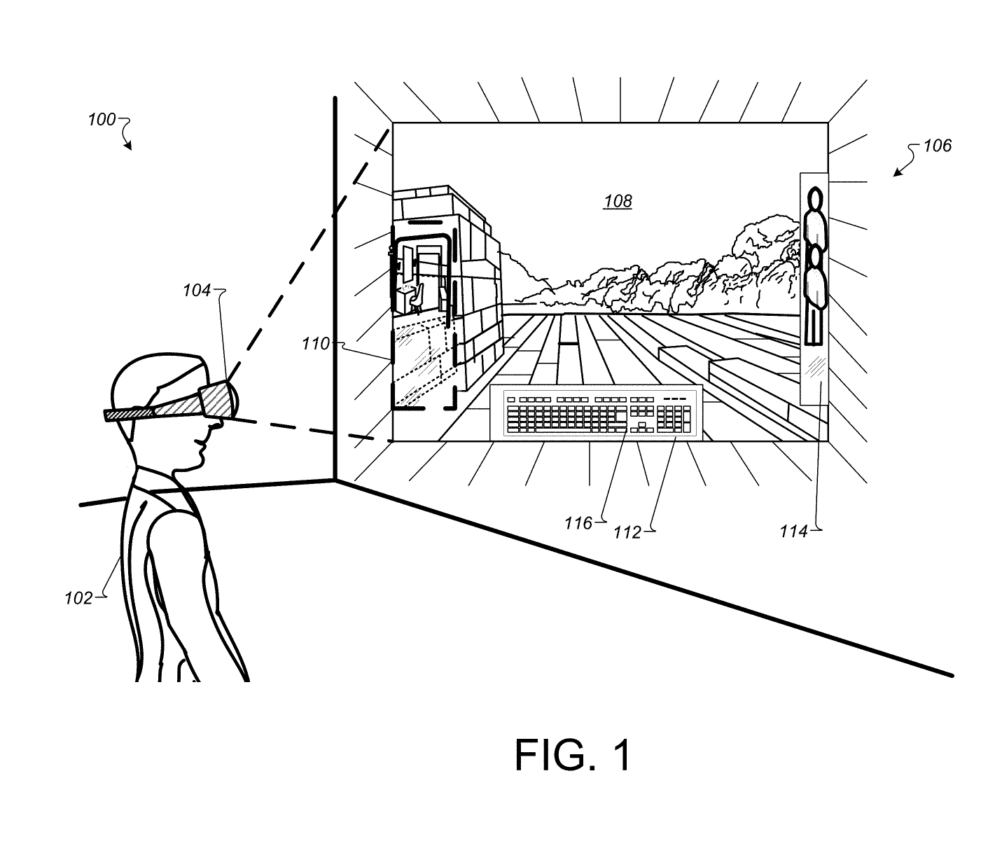

Referring to the example implementation in FIG. 1, a user 102 is shown wearing a VR headset/HMD device 104. Device 104 is providing images in a display 106. The display 106 includes virtual content in a display region 108 and various pass-through content in pass-through display regions (e.g., areas) such as display regions 110, 112, and 114. The display region 108 may refer to a display region or view region within one or more GUIs associated with the display of the HMD device 104. The virtual content for the display region 108 may be generated from images, video, computer graphics, or other media. Although a few display regions are depicted within the displays presented in this disclosure, any number of display regions can be configured and depicted within the virtual reality displays described herein.

In some implementations, one or more display regions configurable with system 100 may be repositioned based on a change in user head, gaze, position, or location. For example, if the user accesses a keyboard while typing in the VR space, the user may look at the keyboard to view the keys. If, the user looks upward, the keyboard can shift upward slightly to accommodate the new view angle. Similarly, if the user turns one hundred and eighty degrees from the keyboard, the system 100 can determine that the user is likely not interested in viewing the keyboard any longer and can remove the region with the keyboard from view.

As shown, display region 110 includes content captured from a first camera (not shown) associated with the HMD device 104. The content captured from the first camera may include pass-through content that is captured and configured to be provided to a user in HMD device 104. Display region 110 is shown with a dotted line that may indicate appearance or fading of content as the user moves toward or away from particular physical world objects. In this example, the user may be moving toward a door and accordingly, the pass-through camera may capture the door and surrounding content. Such content may be displayed to the user in display region 110 to indicate that the user is nearing a doorway and may be leaving a particular area. In some implementations, such a display region 110 may be displayed to provide a safety indicator that the user is leaving a room or area.

Display region 112 includes content captured from a second camera (not shown) associated with the HMD device 104. Display region 114 includes content captured from a third camera (not shown) associated with the HMD device 104. In some implementations, pass-through feed (e.g., consecutive images) can be provided from a single camera in a single display area. In other implementations, more than three cameras can be configured to provide one or more display areas. In yet other implementations, a single camera can provide pass-through content to multiple display areas within display 106 including providing pass-through content in the entire display area 108. In some implementations, pass-through content can be displayed in display areas that are outside of a configured virtual content display area in display 106. For example, pass-through content may be displayed above, below, or beside virtual content in the display 106.

Pass-through content can be depicted in a display region surrounding virtual content in region 108, for example, to provide a less invasive feel to the depicted pass-through content. For example, the systems and methods described herein can provide the pass-through content using GUI effects that provide the content at particular times and/or locations within the display and can do so using sensors to detect such key times and/or locations within the display. For example, the content may be provided if the systems described herein detect that the user is gazing toward a region in which pass-through content is configured and/or available. Pass-through content may be available if a region is defined to provide pass-through content and/or if the defined region is triggered by motion occurring near the region, for example. In some implementations, the pass-through cameras used to capture images may register with or assess physical world content and can provide information to the HMD device by direct display or via the communication of data about the physical world using registration identification information and/or location information.

A number of techniques can be used to detect objects in an environment surrounding particular pass-through cameras. For example, an HMD device configured with a depth sensor can be used to determine distance between the user and objects in the physical environment. The depth sensor can be used to generate a model of the environment, which can be used to determine distances from users to modeled objects. Other modeling and/or tracking/detection mechanisms are possible.

In some implementations, the model may include information about other objects or users in the room. For example, the system 200 can detect users in the room at a point in time that a user begins to use the HMD device 204. The detection and subsequent modelling can be based on face recognition techniques, Bluetooth signatures, or other co-presence technologies. Such a model can be updated when a new user enters the room, and after a time threshold of when the HMD device user begins her virtual reality session, one or more communications can be received on the display of the HMD device 204, for example. In one example, a visual or audio notification can be provided to the user of the HMD device 204 to identify and/or announce one or more detected users within the physical room. The notification can include a name or other identifying criteria for the new user entering the physical room. In another example, or concurrently with a new user announcement or notification, camera pass-through imagery or content depicting the new information or new user can be received and cropped and/or otherwise provided in a particular region of space within the display (e.g., region 406, 404, 408, etc.). In some implementations, the provided pass-through content may be partially transparent to maintain the user's sense of being in the virtual environment. In some implementations, the new user is only introduced if the system 200 detects that the new user did not speak or otherwise introduce themselves to the user wearing the HMD device 204, for example.

In operation, the systems and methods described herein can employ cameras on the HMD device 104, placed in an outward facing fashion, to capture images of an environment surrounding a user, for example. The images captured by such cameras can include images of physical world content. The captured images can be embedded or otherwise combined in a virtual environment in a pass through manner. In particular, the systems and methods described herein can judiciously provide pass-through content in selectively portioned views within a user interface being depicted on a display of the HMD device.

As shown in FIG. 1, an example of portioning a display region 112 may include adapting a sliver or thin user interface near the top of the display 108 to fit a GUI with image content depicting video (i.e., camera feed) that captures a physical keyboard sitting on a desk below the eye-line of the user. Here, the image content including keyboard image/video 116 may be displayed in display region 112 on the display 106 in response to user 102 looking downward toward a position associated with a location of the physical keyboard. If the user looks away from the display region 112, the systems and methods may remove region 112 from view on the display 106 and begin to display virtual content in place of the content shown in region 112.

In some implementations, the display areas may depict content in locations in which the physical object is placed in the physical world. That is, the HMD device 104 can be configured to depict video feed or images at a location on the display of the HMD device 104 that corresponds to actual placement of the physical object. For example, the keyboard 116 may be shown in a location (e.g., display area) of the GUI within the display 108 as if the user were looking down directly at a physical keyboard placed on a desk in front of the user. In addition, since pass-through images can be captured and displayed in real time, the user may be able to view the image/video of her hands during use of the keyboard 116 as the user places her hands into a view of the pass-through camera capturing footage in the direction of the keyboard 116.

In general, a number of sensors (not shown) can be configured with the HMD device 104. The sensors can detect an eye gaze direction associated with the user and can depict images of objects, people (or other content captured by cameras) within the line of sight and in the eye gaze direction. In some implementations, a display area can be configured to display image content from a camera feed upon detecting approaching users or objects. For example, display area 114 depicts video pass-through content of two users approaching user 102. This type of display trigger may employ eye gaze, proximity sensors, or other sensing techniques to determine environmental changes surrounding the user.

In some implementations, a user may be in a seated position wearing the HMD device and enjoying virtual content on the display. One or more pass-through cameras may be viewing content surrounding the user. Within the HMD device, the user may gaze upward to view a semi-circular shape at the top of the VR display area that can provide a view of what is happening in the physical world/environment surrounding the user. The view may be in a user interface in the VR display area or slightly outside of the VR display area. The view may be depicted as though the user is seated in a bunker and viewing the surrounding environment (e.g., the room) as a sliver of imagery embedded within the virtual environment. Such a view allows the user to see approaching users, commotion, or stationary objects surrounding the user while still viewing the virtual content. The user can adjust her focus (e.g., change an eye gaze or head movement) to view the physical world environment should she deem it of interest. This may allow the user an advantage to interact with and view physical world objects, co-workers, computer screens, mobile devices, etc., without having to disengage from the virtual world by removing the HMD device.

In one non-limiting example, if the user receives an email on her laptop while engaging in the virtual world via the HMD, the user can look up or down and can be presented a keyboard when looking down and a view of her laptop when looking up. This can allow the user to draft and send an email using pass-through images that can provide information to complete the email task without having to connect the laptop or keyboard to the virtual environment. The user can simply choose to change her eye gaze to engage in activities surrounding the user in the physical world.

In another non-limiting example, a lower spherical-shaped area (e.g., lower one third, one quarter, one eighth, etc.) of an HMD device display can be used to provide images of content surrounding a user using a forward facing camera attached to the HMD device. The area can be configured for using productivity applications which use a mouse and keyboard, for example. The upper area (e.g., upper two-thirds, three-quarters, seven eights, etc.) can be filled by a productive application while the bottom portion of the display can include pass-through content of live-video from the pass-through camera and may depict user actions involving the keyboard or mouse. Thus, as described above, the user can peek down at the keyboard to make sure fingers are aligned or to find the mouse next to the keyboard. Similarly, the user can use the lower area of the display to look down and view her own body in virtual reality. This may alleviate the disorientation that may occur in a typical VR system in which the user looks down while wearing a virtual reality headset/HMD device expecting to see her body, but does not.

In yet another non-limiting example, if a first user is watching a movie with a second user sitting next to the first user, the pass-through camera footage may be provided in windows to provide real-time views of the left, right, or rear views. This may allow the first user to communication with the second user if, for example, the first user turns to the second user while watching the movie. The first user may see the real-time video feed of the second user when looking toward the physical location of the second user.

In another non-limiting example, the user may be viewing a movie in a VR environment using the HMD device while eating popcorn. The user can glance toward the popcorn and in response, the HMD device can display a user interface in a lower portion of the display to show footage of the popcorn in the lap of the user and/or the user reaching to pick up the popcorn. Once the user changes her eye gaze direction back to the movie, the HMD device 104 can detect the change in eye gaze and remove the user interface of the pass-through footage of the popcorn and/or hands. In some implementations, providing pass-through user interfaces can be based on detecting a change in the head, eyes, body, or location of the user. Additional examples will be described in detail below.

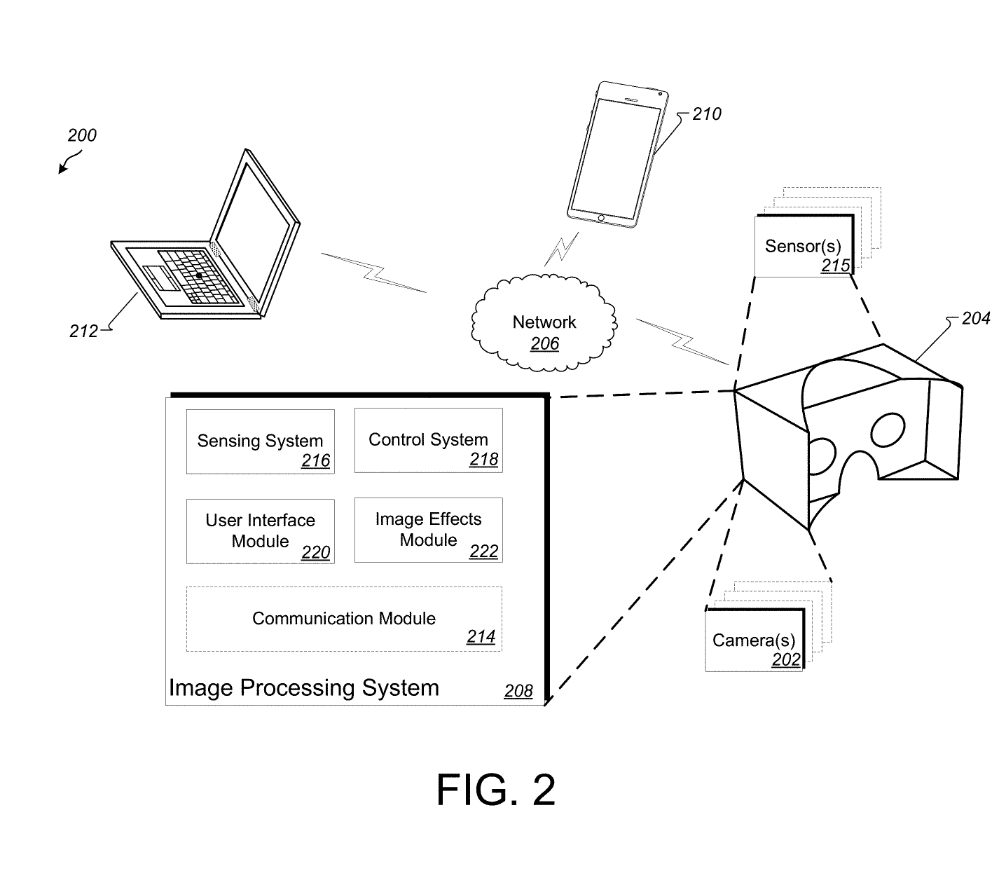

FIG. 2 is a block diagram of an example virtual reality system 200 for implementing 3D virtual reality (VR) environments. In the example system 200, one or more cameras 202 can be mounted on an HMD device 204. The cameras 202 can capture and provide images and virtual content over a network 206, or alternatively, can provide images and virtual content to an image processing system 208 for analysis, processing, and re-distribution to HMD device 204 over a network such as network 206. In some implementations, the cameras 202 can feed captured images directly back into the HMD device 204. For example, in the event that cameras 202 are configured to operate as pass-through cameras installed to capture still images or video of an environment surrounding a user wearing the HMD device 204, the content captured by the pass-through cameras can be directly transmitted and displayed on the HMD device 204 or processed by system 208 and displayed on the HMD device 204.

In some implementations of system 200, a mobile device 210 can function as at least one of the cameras 202. For example, the mobile device 210 can be configured to capture images surrounding the user and may be seated within HMD device 204. In this example, an onboard, outward facing camera installed within device 210 can be used to capture content for display in a number of display areas designated for displaying pass-through content.

In some implementations, image content can be captured by the mobile device 210 and combined with a number of images captured by cameras 202. Such images can be combined with other content (e.g., virtual content) and provided to the user in an aesthetic way so as to not detract from the virtual experience occurring from an area in the HMD device providing virtual content. For example, images captured from mobile device 210 and/or cameras 202 can be provided in an overlay or as a portion of a display in a non-obtrusive way of providing information to the user accessing the HMD device. The information may include, but is not limited to images or information pertaining to approaching objects, animals, people, or other moving or non-moving objects (animate or inanimate) within view of cameras associated with device 204. The information can additionally include augmented and/or virtual content embedded, overlaid, or otherwise combined with captured image content. For example, captured image content can be composited, modified, spliced, corrected, or otherwise manipulated or combined to provide image effects to the user accessing HMD device 204.

As used herein, compositing image content includes combining of visual content (e.g., virtual objects, video footage, captured images, and/or scenery) from separate sources into at least one view for display. The compositing may be used to create the illusion that the content originates from portions of the same scene. In some implementations, the composited image content is a combination of a virtual scene and a physical world scene viewed by the user or (viewed by a pass-through camera). The composited content may be obtained or generated by the systems described herein. In some implementations, compositing image content includes the replacement of selected parts of an image with other content from additional images.

The HMD device 204 is shown in FIG. 1 in a perspective view. The HMD device 204 may include a housing coupled, for example, rotatably coupled and/or removably attachable, to a frame. An audio output device (not shown) including, for example, speakers mounted in headphones, may also be coupled to the frame. In some implementations, the HMD device 204 may include a sensing system 216 including various sensors and a control system 218 including one or more processors and various control system devices to facilitate operation of the HMD device 204. In some implementations, the HMD device 204 may include cameras 202 to capture still and moving images of the real world environment outside of the HMD device 204.

The cameras 202 can be configured for use as capture devices and/or processing devices that can gather image data for rendering content in a VR environment. Although cameras 202 are shown as a block diagram described with particular functionality herein, cameras 202 can take the form of any of the implementation housed within or affixed to a VR headset/HMD device. In general, the cameras 202 can communicate with image processing system 208 via communications module 214. The communication can include transmission of image content, virtual content, or any combination thereof. The communication can also include additional data such as metadata, layout data, rule-based display data, or other user or VR director-initiated data. In some implementations, the communication module 214 can be used to upload and download images, instructions, and/or other camera related content. The communication may be wired or wireless and can interface over a private or public network.

In general, the cameras 202 can be any type of camera capable of capturing still and/or video images (i.e., successive image frames at a particular frame rate). The cameras can vary as to frame rate, image resolution (e.g., pixels per image), color or intensity resolution (e.g., number of bits of intensity data per pixel), focal length of lenses, depth of field, etc. As used herein, the term “camera” may refer to any device (or combination of devices) capable of capturing an image of an object, an image of a shadow cast by the object, an image of light, dark, or other remnant surrounding or within the image that may represent the image in the form of digital data. While the figures depict using one or more cameras, other implementations are achievable using different numbers of cameras, sensors, or combinations thereof

The HMD device 204 may represent a virtual reality headset, glasses, one or more eyepieces, or other wearable device or combinations of devices capable of providing and displaying virtual reality content. The HMD device 204 may include a number of sensors, cameras, and processors including, but not limited to a graphics processing unit programmed to bind textures of image content obtained from pass-through cameras 202. Such textures may refer to texture mapping units (TMUs), which represent a component in the GPU capable to rotate and resize a bitmap to be placed as a texture onto an arbitrary plane of a particular three-dimensional object. The GPU may user TMUs to address and filter such textures. This can be performed in conjunction with pixel and vertex shader units. In particular, the TMU can apply texture operations to pixels. The GPU may also be configured to determine a location within the user interface in which to display such textures. In general, binding textures may refer to binding image textures to VR objects/targets.

In some implementations, the HMD device 204 may include a configurable user interface associated with the display of device 204. In some implementations, the HMD device 204 (or other system in system 200) also includes a hardware compositing layer operable to display image content retrieved from pass-through cameras. The hardware composting layer can composite the image content within virtual content displayed on the HMD device, 204. The display may be configured in a location on the user interface of the display of the HMD 204 according to a shaped stencil selected by a user operating the HMD device 204, for example.

In operation, the HMD device 204 can execute a VR application (not shown) which can playback received and/or processed images to a user. In some implementations, the VR application can be hosted by one or more of the computing devices 208, 210, or 212, shown in FIG. 2. In one example, the HMD device 204 can provide video playback of a scene captured by cameras 202 or mobile device 210. For example, the HMD device 204 can be configured to provide pass-through content depicting portions of approaching objects or users. In some implementations, device 204 can be configured to provide pass-through content in multiple view areas of a display associated with device 204.

Upon capturing particular images using any of cameras 202 or other externally installed camera to system HMD 204 (or communicably coupled device), the image processing system 208 can post-process or pre-process the image content and virtual content and provide combinations of such content via network 206 to for display in HMD device 204, for example. In some implementations, portions of video content or partial image content can be provided for display in the HMD device 204 based on predefined software settings in the VR application, director settings, user settings, or other configuration rules associated with the HMD device 204.

In operation, the cameras 202 are configured to capture image content that can be provided to the image processing system 208. The image processing system 208 can perform a number of calculations and processes on the images and can render and provide the processed images to the HMD device 210, over network 206, for example. In some implementations, the image processing system 208 can also provide the processed images to mobile device 210 and/or to computing device 212 for rendering, storage, or further processing. In some implementations, a number of sensors 215 may be provided to trigger camera captures, locational information, and/or trigger display of image content within HMD device 210.

The image processing system 208 includes a sensing system 216, a control system 218, a user interface module 220, and an image effects module 222. The sensing system 216 may include numerous different types of sensors, including, for example, a light sensor, an audio sensor, an image sensor, a distance/proximity sensor, an inertial measurement unit (IMU) including for example an accelerometer and gyroscope, and/or other sensors and/or different combination(s) of sensors. In some implementations, the light sensor, image sensor and audio sensor may be included in one component, such as, for example, a camera, such as cameras 202 of the HMD 204. In general, the HMD device 204 includes a number of image sensors (not shown) coupled to the sensing system 216. In some implementations, the image sensors are deployed on a printed circuit board (PCB). In some implementations, the image sensors are disposed within one or more of the cameras 202.

In some implementations, the system 200 may be programmed to detect a change in a head position of a user operating the HMD device 204. The system 200 can initiate display of updated image content in a first region of a user interface associated with the display of the HMD device 204. The first region may be composited into content displayed in a second region of the display (i.e., configurable user interface). The updated image may include content associated with a real-time image feed obtained by at least one of the pass-through cameras.

The control system 218 may include numerous different types of devices, including, for example, a power/pause control device, audio and video control devices, an optical control device, a pass-through display control device, and/or other such devices and/or different combination(s) of devices. In some implementations, the control system 218 receives input via the user or from a sensor on the HMD and provides one or more update user interfaces. For example, the control system 218 may receive an update to the eye gaze of associated with the user and can trigger display of pass-through content in one or more display areas based on the updated eye gaze.

The user interface module 220 can be used by a user or VR director to provide a number of configurable user interfaces within a display associated with HMD device 204. Namely, the user interface module 220 can provide a tool for generating virtual reality interfaces. The tool may include a number of regions in a virtual reality user interface, a plurality of overlays for providing image content retrieved from a plurality of pass-through cameras within at least one of the plurality of regions, and a plurality of selectable stencils configured to define display behavior of the plurality of overlays and the plurality of regions according to detected events.

Stencils can be configured to place boundaries between pass-through content and virtual content being depicted in a display of an HMD device. The boundaries may be visible or camouflaged, but can generally function to embed pass-through content into virtual content. Stencils may be used, in general, to define positions within a display region in which objects (virtual or physical) may be presented and/or drawn. Stencils can take any shape or space to define a boundary for displaying image content within the display of the HMD device.

The image effects module 222 can be used to define display behavior of the particular overlays including providing image content in response to detecting approaching physical objects. The image effects module 222 can additionally receive configuration data for displaying a number of regions within the display including displaying one or more overlays according to a VR director or user-selected stencil, as described throughout this disclosure.

In the example system 200, the devices 208, 210, and 212 may be a laptop computer, a desktop computer, a mobile computing device, or a gaming console. In some implementations, the devices 208, 210, and 212 can be a mobile computing device that can be disposed (e.g., placed/located) within the HMD device 204. The mobile computing device 210 can include a display device that can be used as the screen for the HMD device 204, for example. Devices 208, 210, and 212 can include hardware and/or software for executing a VR application. In addition, devices 208, 210, and 212 can include hardware and/or software that can recognize, monitor, and track 3D movement of the HMD device 204, when these devices are placed in front of or held within a range of positions relative to the HMD device 204. In some implementations, devices 208, 210, and 212 can provide additional content to HMD device 204 over network 206. In some implementations, devices 202, 204, 208, 210, and 212 can be connected to/interfaced with one or more of each other either paired or connected through network 206. The connection can be wired or wireless. The network 206 can be a public communications network or a private communications network.

Computing devices 210 and 212 may be in communication with the HMD device (e.g., device 204) worn by the user. In particular, mobile device 210 may include one or more processors in communication with the sensing system 216 and the control system 218, and memory accessible by, for example, a module of the control system 218, and a communication module 214 providing for communication between device 210 and another, external device, such as, for example, device 212, or HMD device 204 directly or indirectly coupled or paired with device 210.

The system 200 may include electronic storage. The electronic storage can include non-transitory storage media that electronically stores information. The electronic storage may be configured to store captured images, obtained images, pre-processed images, post-processed images, etc. Images captured with any of the disclosed camera-bearing devices can be processed and stored as one or more streams of video, or stored as individual frames.

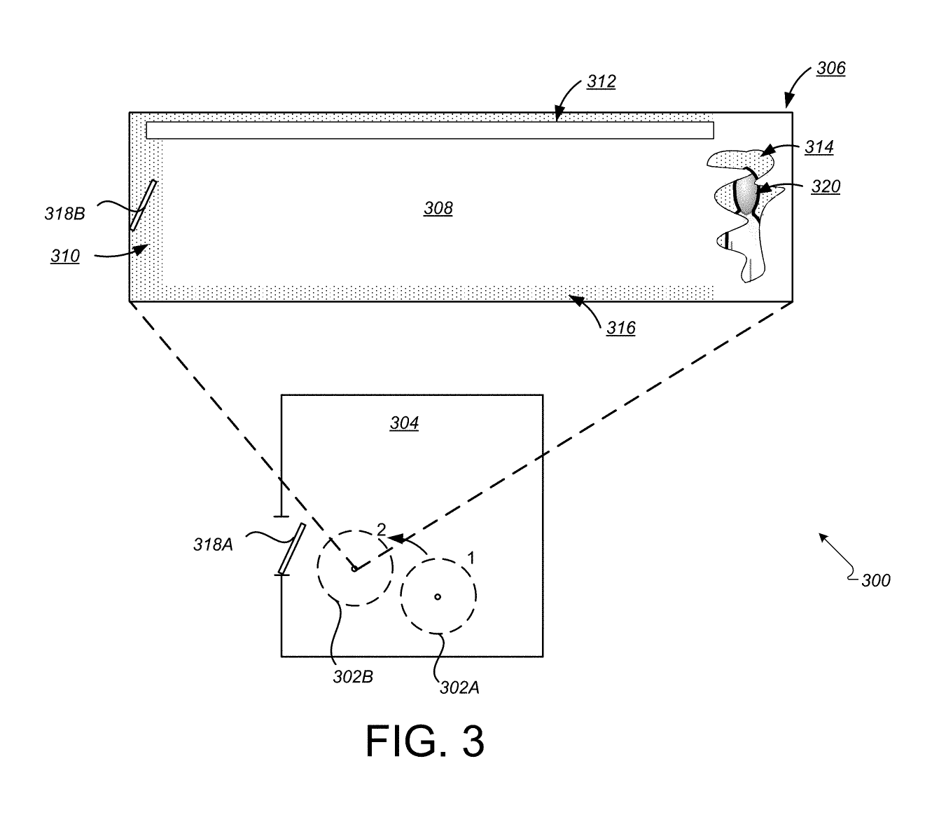

FIG. 3 illustrates an example visual field of view 300 for a user moving while wearing an HMD device. In this example, a user is represented at position 302A and 302B as she moves from one location in room 304 to another. In a VR system, a user may physically move in a prescribed physical space in which the system is received and operated. In this example, the prescribed physical space is room 304. However, room 304 may be expanded or moved to other areas as the user moves through doorways, hallways, or other physical space. In one example, the system 200 may track user movement in the physical space, and cause the virtual world to move in coordination with the movement of the user in the physical world. This positional tracking may thus track a position of the user in the physical world and translate that movement into the virtual world to generate a heightened sense of presence in the virtual world.

In some embodiments, this type of motion tracking in the space may be accomplished by, for example, a tracking device such as a camera positioned in the space, and in communication with a base station generating the virtual world in which the user is immersed. This base station may be, for example, a standalone computing device, or a computing device included in the HMD device worn by the user. In the example implementation shown in FIG. 3, a tracking device (not shown), such as, for example, a camera, can be positioned in a physical, real world space, and can be oriented to capture as large a portion of the room 304 as possible with its field of view.

The user accessing the virtual world in room 304 may experience (e.g., view) content on a display 306. Display 306 may represent a display on an HMD device that the user is wearing to view virtual content. Display 306 includes a number of display regions, each of which can provide user interface content and imagery. A main display region 308 can be configured to provide virtual content such as movies, games, software, or other viewable content. In addition, a number of pass-through regions can be provided by default or upon triggering the region. For example, pass-through display regions 310, 312, 314, and/or 316 may be provided at all times or upon the triggering of one or more predetermined conditions. In some implementations, some or all of display regions 310, 312, 314, and/or 316 may be pre-defined pass-through regions configured to display pass-through content. In general, any combination of a virtual reality user, a virtual reality director, and/or a software developer can configure and define such regions. That is, the regions can be manufacturer defined or end-user defined.

The display 306 may include a number of user interfaces (e.g., display regions, pass-through display regions, etc.), any of which can be updated to provide imagery of virtual content as well as content being captured in an environment around a user accessing display 306 in an HMD device. As such, the user interface content that can be generated and displayed to the user in display 306 may include content outside a field of view of the user, for example, until the user looks toward particular content. In one example, the user may be looking at her monitor until she is faced with a screen that asks her to type an unknown keyboard symbol. At that point, the user may look down to view her keyboard. Accordingly, display 306 can react to the change of eye gaze or (head position or tilt) by displaying images and/or video of her actual keyboard in a pass-through display region, such as region 316 (depicted here as a shaded area at the bottom of display 306).

The pass-through display region 310 is indicated in a dotted line pattern and no content is currently depicted, as shown in FIG. 3. A door 318B (corresponding to door 318A) is shown within pass-through display region 310. Here, the physical door may be displayed within the region 310 at all times. Other objects or content can also be depicted in pass-through display region. For example, if a person were to enter the room 304 through the door 318A, the door 318B may be shown in region 310 in addition to the user that walked through the door 318A. This may be depicted in real time and the content shown in region 310 may be faded in or out, or otherwise displayed according to predefined rules. In some implementations, the pass through display region 310 may not depict the door unless, for example, the user accessing the HMD device in room 304 is in position 302B. If the user were in position 302A, content may not be depicted in region 310 and ay continue to be suppressed or unconsidered for display until additional action occurs near region 310 or until the user looks or glances toward region 310, for example.

Different modes of display within pass-through regions can be configured. For example, a VR director or user interface designer may place display regions within or around a main display area for virtual content. In some implementations, the user of the HMD device can choose which areas and/or shapes may be designated to receive pass-through content.

In general, the display regions may be a myriad of shapes and sizes that can be generated to display pass-through content. For example, a user may draw or paint a display area in which she wishes to view pass-through content. One example of such a display area is region 314 in which the user painted a brushstroke-sized pass-through region in which to receive pass-through content. Other shapes are, of course, possible. Some example shaped areas for providing pass-through content may include, but are not limited to, circles, ovals, larger or smaller brushstroke-shaped, squares, rectangles, lines, user-defined shapes, etc.

As shown in FIG. 3, pass-through region 314 depicts a user 320 approaching the user 302A/B wearing the HMD device that is depicting content in display 306. Here, the user 320 appears to be approaching the user 302A/B and as such, the region 314 displays the user 320 using pass-through camera feed. Region 314 may have been selected by the user to be a particular shape and to behave in a particular way upon detecting available pass-through content. For example, region 314 may be configured to be displayed as an overlay upon detecting movement from the front and right of the user 302A/B.

In some implementations, pass-through regions may be provided using blended views. A blended view may include using one or more stencils to outline a display region which can be bended into VR content. In general, a stencil may represent a shape or other insert-able portion (e.g., one or more pixels) that can represent pass-through content within virtual content. Stencils shapes may include, but are not limited to, circles, squares, rectangles, starts, triangles, ovals, polygons, lines, single or multiple pixels selected by a user, brush stroke shaped (e.g., user-defined), or other definable section or shape that is the same size or smaller than a display associated with an HMD device.

Each pixel within the stencil can be configured to be painted with virtual content, pass-through content, or a combination of both to provide for blended content, superimposed content, or otherwise opaque or transparent portions of either type of content. In one non-limiting example, a stencil can be defined by a user, VR director, or designer to provide 25 percent physical world (e.g., pass-through content) and 75 percent virtual content. This may result in transparent looking pass-through content over virtual content. Similarly, if the virtual content were to be configured at 100 percent, the pass-through content is not displayed and instead, virtual content is shown in the pass-through region.

In some implementations, pass-through regions may be connected or tethered to particular aspects of the user. For example, one or more pass-though areas may be associated with the user through login credentials or other identifying factor. In some implementations, the pass-through regions may be tethered to the location of the user, and as such, can be positioned to appear hanging from the user or the user's HMD device in a manner such that the user can look up or over or down and view content in a dangling pass-through region. In another example, the pass-through region may be tethered to the user in a manner to always be provided in a same area on a display regardless of where the user is glancing. For example, region 316 may be dedicated space providing a downward view of feet associated with the user. Such a region can ensure that the user does not trip over anything while experiencing virtual reality content.

In operation, as the user moves from 302A to 302B, a tracking device or camera (not shown) may track the position of the user and/or may track movements or objects surrounding the user. The tracking can be used to display content within a number of pass-through regions 310, 312, 314, 316, or other unlabeled region within display 306.

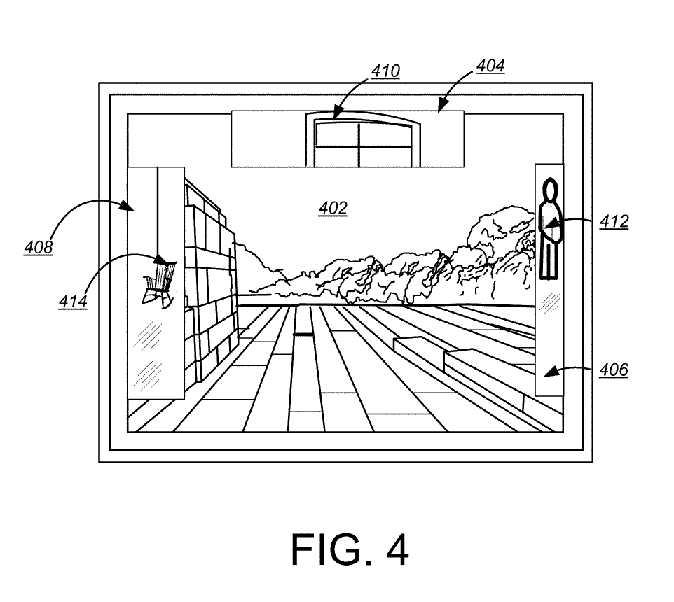

FIG. 4 illustrates an example virtual content and pass-through camera content in the HMD device. Here, a user may be accessing an HMD device, such as HMD device 204 and may be viewing virtual scenes at content region 402. A number of pass-through regions can be displayed at various times or simultaneously. As shown, pass-through regions 404, 406, and 408 are shown. Here, example region 404 may be shown to the user if, for example, the user looks upward. An upward glance may indicate to the virtual system (i.e., HMD device 204) that the user wishes to view physical world content. Region 404 shows the user that the top of a window 410 in the physical world is viewable in her pre-configured pass-through region 404. The camera that captured the image of the window 410 may have additional video footage and coverage of surrounding areas, but has simply displayed a portion of such content because region 404 is configured to be a particular size. Similarly, if a user 412 is detected within the physical world surrounding the user wearing the HMD device, then one of the pass-through regions can display such content as seen by user 412. This may be based on where user 412 is standing within the physical world, or may be based on a particular direction in which the HMD device user is determined to be looking. In another example, the user may wish to view pass-through areas of the physical room surrounding her while accessing virtual content. Such a view can be provided within region 402. In this example, the pass-through content shows a wall and chair 414 in region 408.

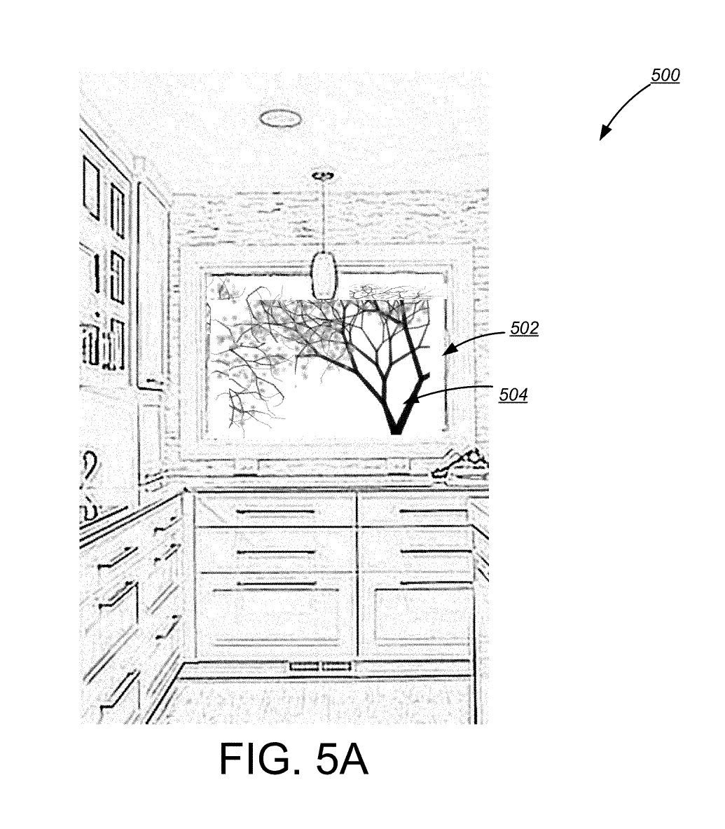

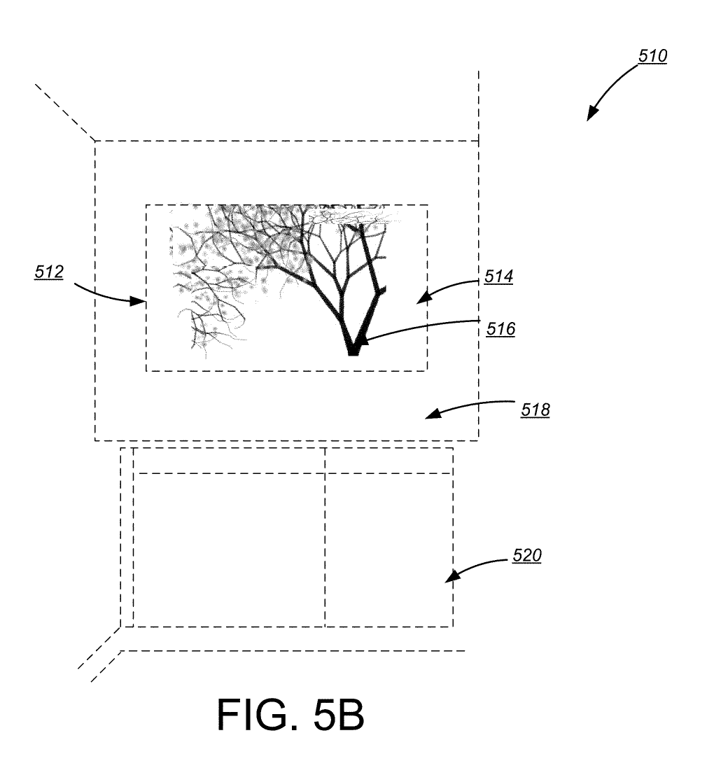

FIG. 5A illustrates an example of physical world content 500 in a partial view of a kitchen window 502 depicting physical world content, such as a tree 504. The tree 504 is an image or video of a portion of a real world yard viewable from the window 502. In general, content 500 illustrates what a user would see in a portion of her kitchen without wearing an HMD device. For example, while viewing physical world content, the user may see details including drawers, drawer pulls, window frames, cabinets, textures, etc. In addition, the user can look out the window 502 to see physical content (e.g., tree 504) or other objects outside the window 502.

Upon placing an HMD device on her head, additional views of the same content in addition to virtual content may be provided to the user in the display of the HMD device. FIG. 5B illustrates an example of content 510 physical content 516 from pass-through images in addition to virtual content in the HMD device worn by the user. In this example, a user wearing HMD device 204, for example, has configured a cut-in region 512 (e.g., portal) that depicts a window 514 from the physical world (i.e., corresponding to an image or video of window 502 in FIG. 5A). The cut-in window 512 is configured to receive streamed or otherwise provided imagery of actual physical content in the display of the HMD device 204 that corresponds to content viewable outside the physical window 502. That is, while the user is immersed in a virtual reality experience, she can be in her physical kitchen (shown in FIG. 5A) experiencing virtual content in the HMD device 204, and can look out the window 502 (represented in her virtual view as window 514 in cut-in 512) to view actual physical world content in the exact location and placement that the physical content exists in the physical world. Such content (and any other physical world content viewable from window 502) can be captured by pass-through cameras affixed to HMD device 204, for example, and configured to be provided to the user based on detected movement, detected circumstances, preconfigured rules, and/or other director or user configurable display options.

Additional content can be provided to the user during a VR experience. For example, FIG. 5B shows portions of wall 518 and cabinets 520 that exist in the physical world of the user's kitchen. These views may be transparent, semi-transparent, lightly outlined, or signified another visual way to indicate that physical objects are present around the user experiencing virtual content. Such content can be provided, for example, based on detected objects, preconfigured scans, and models of the environment surrounding the user.

In this example, the system 200 can be configured to scan a physical room (e.g., kitchen 500) and produce a model of the room (e.g., kitchen 510). The user and/or virtual content creator can be provided a cutting tool to cut in particular regions of the room based on this model. The cut-in region(s) (e.g., 512) can be presented in the virtual world alongside virtual content such that the user can always see pass-through content through the cut-in regions upon directing her view toward the cut-in regions. For example, if the user enjoys looking out a window in her office, she can use the cutting tool to cut out a space (e.g., region 514) for the window. The window may be provided in the virtual world while the user is wearing the HMD device and can be displayed for as long as the user wishes. Thus, anything that occurs outside the window is recorded via the pass-through camera and provided to the user in the cut-in region. This is possible because the virtual room can be mapped to the physical space. The user is able to peek out from the virtual world back into the physical world in a unique way. Such a cut can also by used to dynamically cut portals on face recognition of users entering physical spaces such that they can be provided to the user in an area of the HMD display, selected by the user.

In another example, the user may be seated in a chair in a room during a VR experience. A physical doorway may exist behind the user in such a room and the user can configure a cut-in area of the door. The cut-in area can be configured to capture camera footage of action, objects, or changes that occur within the opening of the doorway. The VR content can be configured to place a door in the exact location of the physical doorway. In the event that another user walks through or near the doorway and verbally calls to the user engaged in a VR experience, the user can swivel her chair toward the physical doorway and be provided with camera footage of the other user waiting to talk to the user engaged in the VR experience.

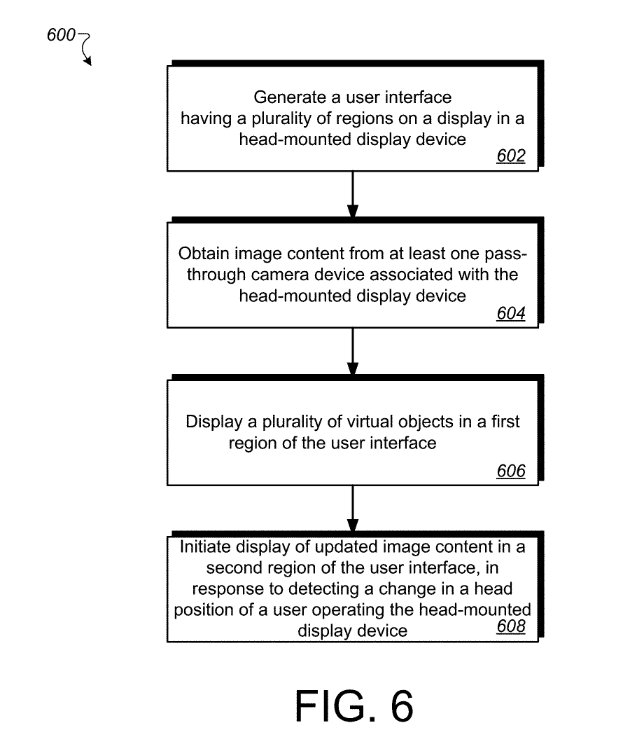

FIG. 6 is a flow chart of a process 600 for providing user interface elements in an HMD device, such as device 204. As shown in FIG. 6, at block 602, the system 200 can generate a virtual reality experience for a user accessing HMD device 204 by generating a user interface within the display of device 204. The user interface may include having a number of regions and can be defined in various shapes. The shapes and sizes of such regions can be selected and defined or predefined by users, virtual content directors, or virtual content programmers.

The HMD device 204 can house, include, or be generally arranged with a number of pass-through camera devices capable of recording content occurring in a physical environment surrounding the user accessing and using HMD device 204. At block 604, the system 200 can obtain image content from the at least one pass-through camera device. For example, the system 200 can retrieve video or image feed from any one of the pass-through cameras 204 affixed to HMD 204. Such content can be configured for display in one or more pass-through regions within a user interface defined by the user, VR director, or programmer, for example.

At block 606, the system 200 can display a number of virtual objects in a first region of the user interface. The first region may substantially fill a field of view associated with the display in the HMD device 204 and the user operating device 204. In response to detecting a change in a head position of the user operating the HMD device 204, the system 200 can initiate display of updated image content in a second region of the user interface, at block 608. For example, the second region may be displayed based on detecting a change in eye gaze of the user. The second region may be composited into content displayed in the first region. The updated image content may be associated with a real-time image feed obtained by at least one of the pass-through cameras. The updated image content may pertain to images captured in a direction corresponding to the change in head position associated with the user. In some implementations, the updated image content includes video composited with the content displayed in the first region, corrected according to at least one eye position associated with the user, rectified based on a display size associated with the head-mounted display device, and projected in the display of the head-mounted display device.

In some implementations, the updated image content includes the second region and a third region composited into the first region. In one non-limiting example, the first region may include scenery surrounding the plurality of virtual objects and the third region may be composited into the first region in response to detecting movement in front of a lens of the at least one pass-through camera.

In some implementations, detecting changes in a head position of the user may include detecting a downward cast eye gaze. In response to such a detection, the system 200 may display a third region in the user interface. The third region may be displayed within the first region and in the direction of the eye gaze and may include a number of images of a body of the user operating the head mounted display device, for example. The images may be originate from the at least one pass-through camera and may be depicted as real-time video feed of the body of the user from a perspective associated with the downward cast eye gaze.

In some implementations, the process 600 may also include determining when or if to remove particular content from display. For example, process 600 may include removing the second region of the user interface from display in response to detecting an additional change in head position of the user. Removing the second region from display may include, but is not limited to fading a plurality of pixels associated with the image content, from opaque to transparent, until the second region is indiscernible (i.e., removed from view) to the user operating the head-mounted display device. Other image effects are possible.

In some implementations, the process 600 may include detecting a number of physical objects in particular image content in which the objects are within a threshold distance from the user operating the HMD device 204, for example. The detection can involve using sensors, measurements, calculations, or image analysis, just to name a few examples. In response to detecting that the user is within a predefined proximity threshold to at least one of the physical objects, the process 600 can include initiating display of a camera feed associated with one or more pass-through cameras and at least one of the physical objects. The camera feed may be displayed in at least one region of the user interface, while the at least one physical object is within a predefined proximity threshold. The initiated display may include at least one object in at least one additional region incorporated into the first region of the user interface. In one example, at least one of the physical objects includes another user approaching the user operating the HMD device 204.

In some implementations, the first region described above may include virtual content while the second region includes video content from pass-through cameras. The video content may be blended into the first region according to system 200 rules or user selection. In general, the first region may be configurable to a first stencil shape and the second region may be configurable to a second stencil shape complimentary to the first stencil shape. Display of the second region may be triggered by a hand motion performed by the user and may be drawn or provided in the shape of a brushstroke placed as an overlay on the first region.

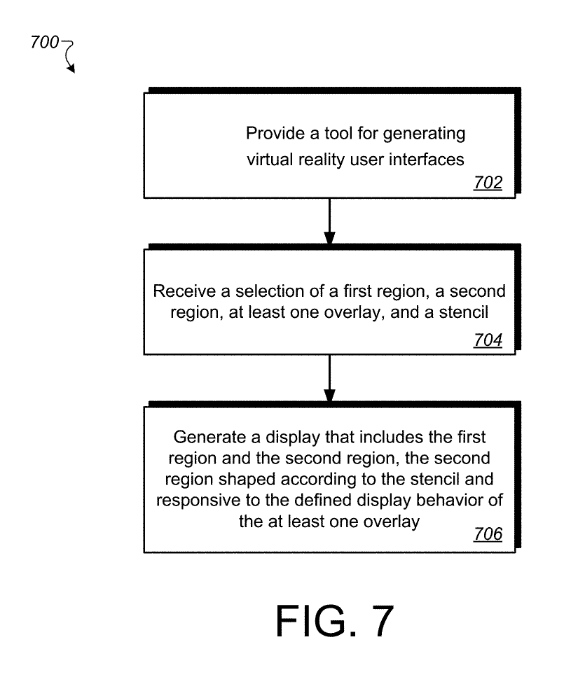

FIG. 7 is a flow chart of a process 700 for generating user interface elements in the HMD device, such as device 204 in system 200. As shown in FIG. 7, at block 702, the system 200 can employ user interface module 220 to carry out one or more functions described herein. For example, a user or director of virtual content can access user interface module 220 to enable a number of configurable user interfaces within a display associated with HMD device 204. Namely, the user interface module 220 can provide a tool for generating virtual reality interfaces. The tool may include a plurality of regions in a virtual reality user interface, a plurality of overlays for providing image content retrieved from a plurality of pass-through cameras within at least one of the plurality of regions, and a plurality of selectable stencils configured to define display behavior of the plurality of overlays and the plurality of regions according to detected events.

The plurality of selectable stencils may include a number of brushstrokes paintable as a shaped overlay image on the first or second region. For example, an image of a painted on brushstroke from left to right on the display can be provided as a cut in or transparent window upon another region within the user interface. A user can use a paintbrush shaped cursor tool (or her location tracked hand) in order to depict a brush stroke on the user interface in the display of HMD device 204, for example. In some implementations, one or more of the plurality of regions in the virtual reality user interface are configurable to be blended with virtual content and cross-faded amongst image content displayed in the user interface based on a pre-selected stencil shape. A brushstroke is one example of a pre-selected stencil shape.

In some implementations, the tool may provide cut-in functionality to allow a user to predefine unconventional shapes and display areas. Such a tool may be used to draw an area or scape an area in a way that the user finds non-intrusive or displaying physical world content. For example, one user may find a long sliver across the top of her display to be non-intrusive and can configure such a display for viewing pass-through content while she is in the virtual world. Another user may wish to view pass-through content off her main virtual view and only view such content if particular gestures or movement is performed. For example, a user may wish to view pass-through content in emergent situations or if, for example, she swipes a particular pattern with her tracked hand gestures. Other triggers are, of course, possible.

At some point during operation of system 200, the user or VR director can provide selections using the tool. The system 200, at block 704 can receive a selection of a first region, a second region, at least one overlay, and a stencil. For example, a user can select a first region 402 (FIG. 4), a second region 406, an overlay indicating about 25% percent transparency such that the image content display in the second region 406 is displayed with 25 percent transparency over the first region 402. The user can also select a stencil for either the first or the second regions. For example, the user may select a rectangular stencil for region 406. Other shapes and sizes are possible.

Upon receiving a selection of the first region from a number of selectable regions, the second region from a number of selectable regions, the overlay from a number of overlays, and the stencil from a number of selectable stencils, the process 700 can include generating a display, at block 706, in which the display includes the first region and the second region and the second region includes at least one overlay shaped according to the stencil. In addition, the second region may be preconfigured to respond to particular user movement or system events. As such, the second region may be responsive to the predefined display behavior of the selected overlay. In some implementations, the defined or predefined display behavior of the overlay may include providing image content in response to detecting approaching physical objects or users.

In one non-limiting example, the process 700 may include receiving configuration data for displaying the first region, the second region, and the at least one overlay according to the stencil. Such configuration data may pertain to timing data, location data, user interface arrangement data, metadata, and particular image data. The system 200 can receive such configuration data and can generate a display that includes the first region and the second region, in which the second region includes at least one overlay shaped according to the stencil, the configuration data, and that is responsive to the defined display behavior for the at least one overlay.

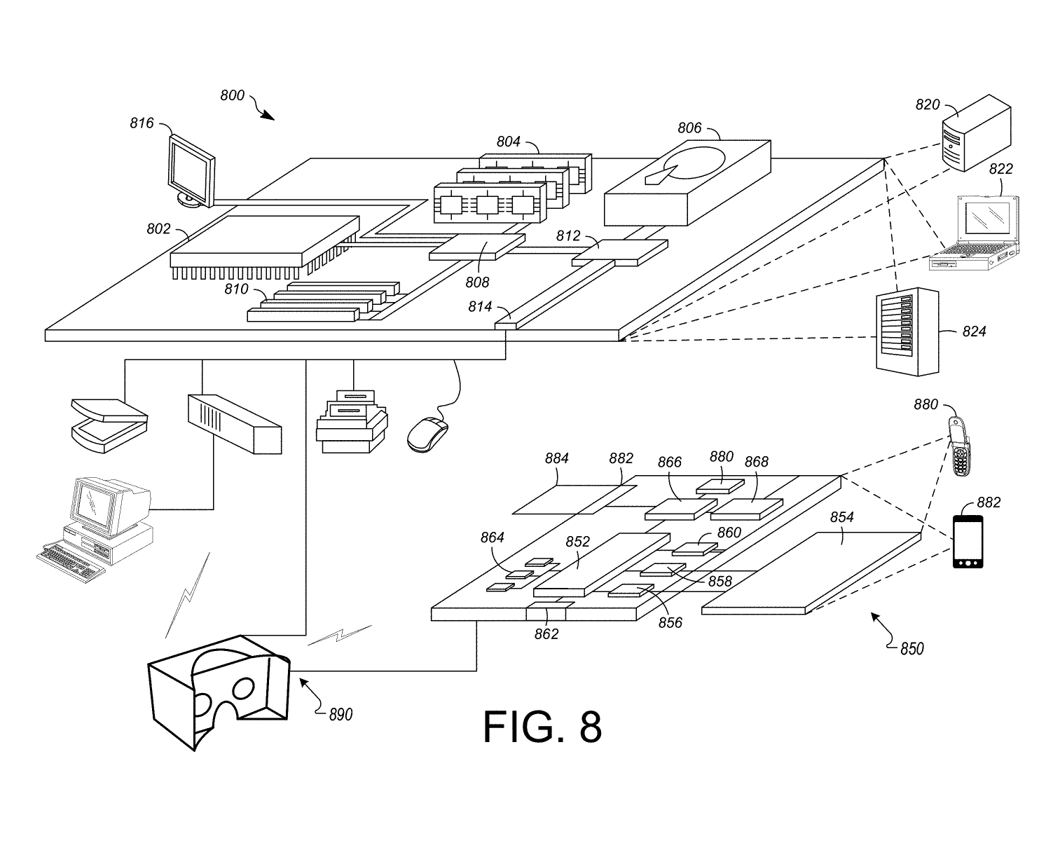

FIG. 8 shows an example of a computer device 800 and a mobile computer device 850, which may be used with the techniques described here. Computing device 800 includes a processor 802, memory 804, a storage device 806, a high-speed interface 808 connecting to memory 804 and high-speed expansion ports 810, and a low speed interface 812 connecting to low speed bus 814 and storage device 806. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. In addition, multiple computing devices 800 may be connected, with each device providing portions of the necessary operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The information carrier is a computer- or machine-readable medium, such as the memory 804, the storage device 806, or memory on processor 802.

The high speed controller 808 manages bandwidth-intensive operations for the computing device 800, while the low speed controller 812 manages lower bandwidth-intensive operations. Such allocation of functions is exemplary only. In one implementation, the high-speed controller 808 is coupled to memory 804, display 816 (e.g., through a graphics processor or accelerator), and to high-speed expansion ports 810, which may accept various expansion cards (not shown). In the implementation, low-speed controller 812 is coupled to storage device 806 and low-speed expansion port 814. The low-speed expansion port, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a personal computer such as a laptop computer 822. Alternatively, components from computing device 800 may be combined with other components in a mobile device (not shown), such as device 850. Each of such devices may contain one or more of computing device 800, 850, and an entire system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provide in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 884 may also be provided and connected to device 850 through expansion interface 882, which may include, for example, a SIMM (Single In Line Memory Module) card interface. Such expansion memory 884 may provide extra storage space for device 850, or may also store applications or other information for device 850. Specifically, expansion memory 884 may include instructions to carry out or supplement the processes described above, and may include secure information also. Thus, for example, expansion memory 884 may be provide as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 884, or memory on processor 852, that may be received, for example, over transceiver 868 or external interface 862.

Device 850 may communicate wirelessly through communication interface 866, which may include digital signal processing circuitry where necessary. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, Wi-Fi, or other such transceiver (not shown). In addition, GPS (Global Positioning System) receiver module 880 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker, e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 880. It may also be implemented as part of a smart phone 882, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In some implementations, the computing devices depicted in FIG. 8 can include sensors that interface with a virtual reality (VR headset/HMD device 890). For example, one or more sensors included on a computing device 850 or other computing device depicted in FIG. 8, can provide input to VR headset 890 or in general, provide input to a VR space. The sensors can include, but are not limited to, a touchscreen, accelerometers, gyroscopes, pressure sensors, biometric sensors, temperature sensors, humidity sensors, and ambient light sensors. The computing device 850 can use the sensors to determine an absolute position and/or a detected rotation of the computing device in the VR space that can then be used as input to the VR space. For example, the computing device 850 may be incorporated into the VR space as a virtual object, such as a controller, a laser pointer, a keyboard, a weapon, etc. Positioning of the computing device/virtual object by the user when incorporated into the VR space can allow the user to position the computing device to view the virtual object in certain manners in the VR space. For example, if the virtual object represents a laser pointer, the user can manipulate the computing device as if it were an actual laser pointer. The user can move the computing device left and right, up and down, in a circle, etc., and use the device in a similar fashion to using a laser pointer.

In some implementations, one or more input devices included on, or connect to, the computing device 850 can be used as input to the VR space. The input devices can include, but are not limited to, a touchscreen, a keyboard, one or more buttons, a trackpad, a touchpad, a pointing device, a mouse, a trackball, a joystick, a camera, a microphone, earphones or buds with input functionality, a gaming controller, or other connectable input device. A user interacting with an input device included on the computing device 850 when the computing device is incorporated into the VR space can cause a particular action to occur in the VR space.

In some implementations, a touchscreen of the computing device 850 can be rendered as a touchpad in VR space. A user can interact with the touchscreen of the computing device 850. The interactions are rendered, in VR headset 890 for example, as movements on the rendered touchpad in the VR space. The rendered movements can control objects in the VR space.

In some implementations, one or more output devices included on the computing device 850 can provide output and/or feedback to a user of the VR headset 890 in the VR space. The output and feedback can be visual, tactical, or audio. The output and/or feedback can include, but is not limited to, vibrations, turning on and off or blinking and/or flashing of one or more lights or strobes, sounding an alarm, playing a chime, playing a song, and playing of an audio file. The output devices can include, but are not limited to, vibration motors, vibration coils, piezoelectric devices, electrostatic devices, light emitting diodes (LEDs), strobes, and speakers.

In some implementations, the computing device 850 may appear as another object in a computer-generated, 3D environment. Interactions by the user with the computing device 850 (e.g., rotating, shaking, touching a touchscreen, swiping a finger across a touch screen) can be interpreted as interactions with the object in the VR space. In the example of the laser pointer in a VR space, the computing device 850 appears as a virtual laser pointer in the computer-generated, 3D environment. As the user manipulates the computing device 850, the user in the VR space sees movement of the laser pointer. The user receives feedback from interactions with the computing device 850 in the VR environment on the computing device 850 or on the VR headset 890.

In some implementations, a computing device 850 may include a touchscreen. For example, a user can interact with the touchscreen in a particular manner that can mimic what happens on the touchscreen with what happens in the VR space. For example, a user may use a pinching-type motion to zoom content displayed on the touchscreen. This pinching-type motion on the touchscreen can cause information provided in the VR space to be zoomed. In another example, the computing device may be rendered as a virtual book in a computer-generated, 3D environment. In the VR space, the pages of the book can be displayed in the VR space and the swiping of a finger of the user across the touchscreen can be interpreted as turning/flipping a page of the virtual book. As each page is turned/flipped, in addition to seeing the page contents change, the user may be provided with audio feedback, such as the sound of the turning of a page in a book.

In some implementations, one or more input devices in addition to the computing device (e.g., a mouse, a keyboard) can be rendered in a computer-generated, 3D environment. The rendered input devices (e.g., the rendered mouse, the rendered keyboard) can be used as rendered in the VR space to control objects in the VR space.

Computing device 800 is intended to represent various forms of digital computers, such as laptops, desktops, workstations, personal digital assistants, servers, blade servers, mainframes, and other appropriate computers. Computing device 850 is intended to represent various forms of mobile devices, such as personal digital assistants, cellular telephones, smart phones, and other similar computing devices. The components shown here, their connections and relationships, and their functions, are meant to be exemplary only, and are not meant to limit implementations of the inventions described and/or claimed in this document.

A number of embodiments have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other embodiments are within the scope of the following claims.

What is claimed is:

1. A method, comprising:
generating a virtual reality experience including generating a user interface, having a plurality of regions, on a display in a head-mounted display device, the head-mounted display device housing at least one pass-through camera device;
obtaining image content from the at least one pass-through camera device;
displaying a plurality of virtual objects in a first region of the plurality of regions in the user interface, the first region substantially filling a field of view of the display in the head-mounted display device; and
in response to detecting a change in a head position of a user operating the head-mounted display device, initiating display of updated image content in a second region of the plurality of regions in the user interface, the second region being composited into content displayed in the first region, the updated image content being associated with a real-time image feed obtained by the at least one pass-through camera.

2. The method of claim 1, further comprising in response to detecting an additional change in head position of the user, removing from view, the second region of the user interface.

3. The method of claim 2, wherein removing the second region from display includes fading a plurality of pixels associated with the image content, from opaque to transparent, until the second region is removed from view to the user operating the head-mounted display device.

4. The method of claim 1, wherein displaying the second region is based on detecting a change in eye gaze of the user.

5. The method of claim 1, wherein the updated image content includes the second region and a third region, of the plurality of regions, composited into the first region, the first region including scenery surrounding the plurality of virtual objects, the third region being composited into the first region in response to detecting movement in front of a lens of the at least one pass-through camera.

6. The method of claim 1, wherein detecting an additional change in head position of the user includes detecting a downward cast eye gaze and in response, displaying a third region in the user interface, the third region being displayed within the first region and in the direction of the eye gaze and including a plurality of images of a body of the user operating the head mounted display device, the images initiated from the at least one pass-through camera and depicted as a real-time video feed of the body of the user from a perspective associated with the downward cast eye gaze.

7. The method of claim 1, wherein the updated image content includes video composited with the content displayed in the first region, corrected according to at least one eye position associated with the user, rectified based on a display size associated with the head-mounted display device, and projected in the display of the head-mounted display device.

8. The method of claim 1, further comprising:
detecting a plurality of physical objects in the image content that are within a threshold distance of the user operating the head-mounted display device; and
in response to detecting, using a sensor, that the user is proximate to at least one of the physical objects, initiating display of a camera feed associated with the pass-through camera and the at least one physical object, in at least one region of the user interface, while the at least one physical object is within a predefined proximity threshold, the initiated display including the at least one object in at least one region incorporated into the first region.

9. The method of claim 1, wherein at least one of the physical objects includes another user approaching the user operating the head-mounted display device.

10. The method of claim 1, wherein the first region includes virtual content and the second region includes video content that is a blended into the first region.

11. The method of claim 1, wherein the first region is configurable to a first stencil shape and the second region is configurable to a second stencil shape complimentary to the first stencil shape.

12. The method of claim 1, wherein display of the second region is triggered by a hand motion performed by the user and in the shape of a brushstroke placed as an overlay on the first region.

13. A system comprising:
a plurality of pass-through cameras,
a head-mounted display device including,
a plurality of sensors,
a configurable user interface associated with the head-mounted display device, and
a graphics processing unit programmed to bind a plurality of textures of image content obtained from the plurality of pass-through cameras and determine a location within the user interface in which to display the plurality of textures.

14. The system of claim 13, wherein the system further includes a hardware compositing layer operable to display image content retrieved from the plurality of pass-through cameras and composite the image content within virtual content displayed on the head-mounted display device, the display being configured in a location on the user interface and according to a shaped stencil selected by a user operating the head-mounted display device.

15. The system of claim 13, wherein the system is programmed to:
detect a change in a head position of a user operating the head-mounted display device, initiate display of updated image content in a first region of the user interface, the first region being composited into content displayed in a second region, the updated image being content being associated with a real-time image feed obtained by at least one of the plurality of pass-through cameras.

16. A method comprising:
providing, with a processor, a tool for generating virtual reality user interfaces, the tool programmed to allow the processor to provide:
a plurality of selectable regions in a virtual reality user interface;
a plurality of overlays for providing image content retrieved from a plurality of pass-through cameras within at least one of the plurality of regions;
a plurality of selectable stencils configured to define display behavior of the plurality of overlays and the plurality of regions, the display behavior being executed in response to at least one detected event;
receiving a selection of a first region from the plurality of selectable regions, a second region from the plurality of selectable regions, at least one overlay from the plurality of overlays, and a stencil from the plurality of selectable stencils; and
generating a display that includes the first region and the second region, the second region including the at least one overlay, shaped according to the stencil and responsive to the defined display behavior of the at least one overlay.

17. The method of claim 16, wherein the defined display behavior of the overlay includes providing the image content in response to detecting approaching physical objects.

18. The method of claim 16, further comprising:
receiving configuration data for displaying the first region, the second region, and the at least one overlay according to the stencil; and
generating a display that includes the first region and the second region, the second region including the at least one overlay shaped according to the stencil, the configuration data, and responsive to the defined display behavior for the at least one overlay.

19. The method of claim 16, wherein the plurality of selectable stencils include a plurality of brushstrokes paintable as a shaped overlay image on the first or second region.

20. The method of claim 16, wherein the plurality of regions in the virtual reality user interface are configurable to be blended with virtual content and cross-faded amongst image content displayed in the user interface based on a pre-selected stencil shape.
